(19) United States
(12) Patent Application Publication
(10) Pub. No.: US 2026/0284595 A1
(43) Pub. Date: Sep. 24, 2026

(54) METHODS FOR CARBON CAPTURE AND METAL RECOVERY AND RELATED SYSTEMS

(71) Applicant: Battelle Energy Alliance, LLC, Idaho Falls, ID (US)

(72) Inventors: Meng Shi, Idaho Falls, ID (US); Luis A. Diaz Aldana, Idaho Falls, ID (US); John R. Klaehn, Idaho Falls, ID (US); Tedd E. Lister, Cotuit, MA (US)

(21) Appl. No.: 19/573,587

(22) Filed: Mar. 20, 2026

Related U.S. Application Data
(60) Provisional application No. 63/774,881, filed on Mar. 20, 2025.

(51) Int. Cl. B01D 53/96; B01D 53/62; B01D 53/78; B01D 61/46; C01F 5/24; C01F 11/18; C01G 51/06; C01G 53/06; C22B 3/00; C22B 3/02; C22B 3/36; C22B 3/42; C22B 7/00; C22B 26/12; C22B 26/20; C22B 26/22; H01M 10/54

(52) U.S. Cl. CPC B01D 53/965; B01D 53/62; B01D 53/78; B01D 61/463; C01F 5/24; C01F 11/183; C01G 51/06; C01G 53/06; C22B 3/02; C22B 3/362; C22B 3/42; C22B 7/006; C22B 23/0453; C22B 26/12; C22B 26/20; C22B 26/22; H01M 10/54; B01D 2252/20405; B01D 2252/20421; B01D 2252/20436; B01D 2257/504; C01P 2002/72

(57) ABSTRACT

A method for CO₂ capture and metal recovery includes combining CO₂ with a solution including an amine compound to form a CO₂-amine stream, combining the CO₂-amine stream with a metal-containing feedstream to form one or more metal salts and an amine-metal solution, the one or more metal salts including carbon, the amine-metal solution including the amine compound and additional metals of the metal-containing feedstream. The method further includes recovering the one or more metal salts, electrochemically separating the amine compound from the additional metals of the amine-metal solution, recovering the amine compound, and recovering one or more of the additional metals. Related systems are also disclosed.

### CROSS-REFERENCE TO RELATED APPLICATION

This application claims the benefit under 35 U.S.C. § 119(e) of U.S. Provisional Patent Application Ser. No. 63/774,881, filed Mar. 20, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to carbon capture systems, such as amine-based carbon capture systems and related methods.

### BACKGROUND

Carbon dioxide (CO₂) emissions have been recognized as a major contributor to climate change since their heat-absorbing properties were first identified. The concentration of CO₂ in the atmosphere has risen from approximately 280 ppm in the 18th century to over 420 ppm in recent years, driven largely by human activities such as fossil fuel combustion. This increase has led to significant climate impacts, including global warming, ocean acidification, and rising sea levels.

To address these challenges, carbon capture and storage (CCS) technologies have been developed to reduce net CO₂ emissions by capturing CO₂ from industrial and power generation processes. Amine-based carbon capture (i.e., amine scrubbing) is one of the most effective and widely implemented methods for CO₂ capture, leveraging the reversible chemical interaction between amines and CO₂ to separate and remove CO₂ from gas streams. This process conventionally involves CO₂ absorption in aqueous amine solutions, followed by regeneration of the amines through heating (i.e., stripping), yielding purified CO₂ for sequestration or utilization.

However, amine-based CO₂ capture systems face several challenges. Amines are prone to degradation due to oxidation and thermal stress during the stripping process. This degradation leads to the formation of byproducts that contaminate process equipment, reduce process efficiency, and contribute to equipment corrosion. Amines are often lost through volatilization during the stripping process or entrainment in waste streams, creating environmental and operational concerns. Furthermore, conventional amine regeneration processes are energy intensive and often limited in effectiveness.

### BRIEF SUMMARY

Accordingly, a method for CO₂ capture and metal recovery is disclosed. The method for CO₂ capture and metal recovery includes combining CO₂ with a solution including an amine compound to form a CO₂-amine stream, combining the CO₂-amine stream with a metal-containing feedstream to form one or more metal salts and an amine-metal solution, the one or more metal salts including carbon, the amine-metal solution including the amine compound and additional metals of the metal-containing feedstream, recovering the one or more metal salts, electrochemically separating the amine compound from the additional metals of the amine-metal solution, recovering the amine compound, and recovering one or more of the additional metals.

Accordingly, a CO₂ capture and amine regeneration system is disclosed. The CO₂ capture and amine regeneration system includes a CO₂ capture apparatus configured to absorb CO₂ and form a CO₂-amine composition, a CO₂ mineralization apparatus configured to contain a metal-containing feedstream, the CO₂ mineralization apparatus configured to receive the CO₂-amine composition, mineralize the CO₂, and produce an amine-metal solution including the amine and additional metals of the metal-containing feedstream, and an electrochemical apparatus configured to receive the amine-metal solution including the amine and the additional metals and separate the amine from the additional metals.

Accordingly, a method for CO₂ capture and lithium recovery is disclosed. The method for CO₂ capture and lithium recovery includes combining CO₂ with a composition including methyl cyclohexylamine (MCA) to form a CO₂-MCA composition, combining the CO₂-MCA composition with a lithium-containing solution including one or more additional metals to form a solid mass including one or more metal carbonates and a liquid filtrate including the MCA and the lithium, and electrochemically separating the MCA from the lithium in the liquid filtrate to form an MCA-containing phase and a lithium-containing phase.

### BRIEF DESCRIPTION OF THE SEVERAL VIEWS OF THE DRAWINGS

FIG. 1 is a flow diagram of a CO₂ capture and amine regeneration system, in accordance with embodiments of the disclosure;

FIG. 2A illustrates an electrochemical apparatus, in accordance with embodiments of the disclosure;

FIG. 2B illustrates the electrochemical apparatus of FIG. 2A at a particular stage of operation, in accordance with embodiments of the disclosure;

FIG. 3 illustrates an electrochemical apparatus, in accordance with embodiments of the disclosure;

FIG. 4A depicts an exemplary lithium-ion battery leachate composition, in accordance with embodiments of the disclosure;

FIG. 4B depicts an exemplary amine-metal composition formed from the lithium-ion battery leachate composition of FIG. 4A and a CO₂-saturated amine composition, in accordance with embodiments of the disclosure;

FIG. 4C depicts a two-phase liquid solution formed after electrodialysis of the amine-metal composition, in accordance with embodiments of the disclosure;

FIG. 5A depicts a simulated brine solution, in accordance with embodiments of the disclosure;

FIG. 5B depicts a suspension formed from the simulated brine solution of FIG. 5A and a CO₂-saturated amine composition, in accordance with embodiments of the disclosure;

FIG. 5C depicts a solid mass formed from the suspension of FIG. 5B, in accordance with embodiments of the disclosure;

FIG. 5D depicts an amine-metal solution formed from the suspension of FIG. 5B, in accordance with embodiments of the disclosure;

FIG. 5E depicts phase separation after electrodialysis of the amine-metal solution of FIG. 5D, in accordance with embodiments of the disclosure;

FIG. 6 depicts an XRD spectrum of the solid mass of FIG. 5C, in accordance with embodiments of the disclosure;

FIG. 7A depicts MCA recovery yields under different electrodialysis conditions, in accordance with embodiments of the disclosure;

FIG. 7B depicts lithium yields under different electrodialysis conditions, in accordance with embodiments of the disclosure;

FIG. 7C depicts lithium enrichment ratios under different electrodialysis conditions, in accordance with embodiments of the disclosure; and

FIG. 7D depicts NMR spectra of fresh and recovered MCA, in accordance with embodiments of the disclosure.

### DETAILED DESCRIPTION

The illustrations presented herein are not actual views of any carbon capture systems (e.g., a CO₂ capture and amine regeneration system, an amine-based carbon capture system), or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any CO₂ capture and amine regeneration system when utilized in a conventional manner. Furthermore, these terms may refer to an orientation of elements of any CO₂ capture and amine regeneration system as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

According to embodiments described herein, a method of capturing and storing carbon dioxide (CO₂) includes capturing the CO₂ using an aqueous amine solution which includes an amine compound that is at least partially insoluble in water. The CO₂ is combined with (e.g., bubbled through) the aqueous amine solution until saturation to form a CO₂-saturated amine stream in which the amine compound is soluble. The CO₂ reacts with the amine compound to form a carbamate compound. The carbamate compound may further react with water to form a bicarbonate compound, releasing the amine compound into solution. The CO2-saturated amine stream may thus include solubilized amine compound and dissolved CO₂ in the form of the carbamate compound, the bicarbonate compound, or a combination thereof.

The dissolved CO₂ of the CO₂-saturated amine stream may be mineralized (e.g., solidified) in a CO₂ mineralization process. The CO₂-saturated amine stream is combined (e.g., mixed) with an aqueous metal-containing feedstream (e.g., a lithium-ion battery leachate, a mining process brine, etc.) to convert the dissolved CO₂ in the CO₂-saturated amine stream from a liquid phase to a solid phase. The metal-containing feedstream may include multiple metals, such as one or more alkali metals, alkaline earth metals, transition metals, and rare earth metals. During this CO₂ mineralization process, the dissolved CO₂ reacts with one or more metals of the metal-containing feedstream and precipitates into one or more metal salts including carbon of the dissolved CO₂ (e.g., one or more metal carbonate salts or one or more metal carbamate salts). Following precipitation, vacuum filtration, centrifugation, cyclonic separation, or other mechanical separation techniques may be employed to remove the metal salt from the remaining liquid, forming a solid mass of the one or more metal salts, such as a filter cake including the one or more metal salts including carbon. An aqueous amine-metal solution (e.g., a liquid filtrate) including the amine compound and one or more additional metals of the metal-containing feedstream is also produced. The one or more metal salts in the solid mass may subsequently be separated from one another based on differences in solubility.

The aqueous amine-metal solution including the amine compound and additional metals from the metal-containing feedstream may be introduced into an electrochemical apparatus including an anode, a cathode, an anolyte chamber adjacent to the anode, an acid chamber adjacent to the anolyte chamber, a feed chamber adjacent to the acid chamber, and a catholyte chamber disposed between the feed chamber and the cathode. A cation exchange membrane or a bipolar membrane separates the anolyte chamber from the acid chamber, and a cation exchange membrane separates the feed chamber from the catholyte chamber. An anion exchange membrane separates the acid chamber from the feed chamber. The amine-metal solution is introduced into (e.g., flowed through) the feed chamber while a voltage or current is applied between the anode and the cathode, creating an electric field that drives positively charged species (e.g., protonated amines, metal cations, etc.) toward the cathode. The electrochemical apparatus facilitates transport of the amine compound and additional metals of the amine-metal solution across the cation exchange membrane into the catholyte chamber, allowing the additional metals to form a metal solution including stable metal compounds (e.g., metal hydroxides, metal carbonates, etc.) while the amine compound is deprotonated and remains in a distinct organic layer (e.g., organic phase) on top of the metal solution. The amine compound and metal compounds of the metal solution may be recovered electrochemically at a relatively low temperature. The organic layer containing the amine compound may be decanted or otherwise removed and reused in the CO₂ capture and storage process, while the metal compounds may be recycled or used in industrial applications.

The systems and methods according to embodiments of the disclosure use less energy in amine recovery compared with conventional systems and methods. Furthermore, by mineralizing the CO₂ of the CO₂-saturated amine stream with a metal-containing feedstream, the systems and methods according to embodiments of the disclosure may facilitate treatment of metal waste streams while producing useful products for industrial processes and recycling the amine compound for further use in CO₂ capture and storage. For example, the systems and methods according to embodiments of the disclosure may facilitate treatment of waste water including metals, separation of lithium from recycled lithium-ion batteries, extraction of metals from coal ash, or extraction of rare earth elements from mining leachates.

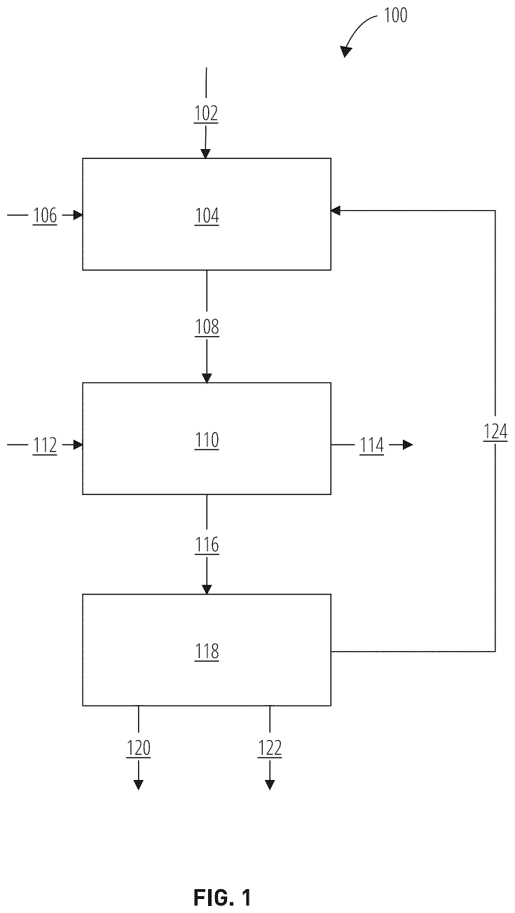

FIG. 1 is a simplified flow diagram of a CO₂ capture and amine regeneration system 100, in accordance with embodiments of the disclosure. The CO₂ capture and amine regeneration system 100 includes a CO₂ capture apparatus 104, a CO₂ mineralization apparatus 110, and an electrochemical (e.g., electrodialysis) apparatus 118. A CO₂ feedstream 106 and an amine-H₂O feedstream 102 are introduced into the CO₂ capture apparatus 104, in which the CO₂ is solubilized in the amine-H₂O feedstream 102 to produce a CO₂-saturated amine stream 108. The CO₂-saturated amine stream 108 and a metal-containing feedstream 112 are introduced into the CO₂ mineralization apparatus 110, which produces a metal salt 114 in solid phase and an amine-metal solution 116 including the amine compound and additional metals of the metal-containing feedstream 112. The amine-metal solution 116 is introduced into the electrochemical apparatus 118, which separates the amine compound from the additional metals in the amine-metal solution 116 and produces a metal solution 120, an acid effluent stream 122, and a recycled amine compound 124. The recycled amine compound 124 may subsequently be reused in the CO₂ capture apparatus 104. For example, the recycled amine compound 124 may be directed from the electrochemical apparatus 118 toward the CO₂ capture apparatus 104 through a recycle line and may be reused in the CO₂ capture apparatus 104. In some embodiments, the recycled amine compound 124 may be concentrated, purified, filtered, dried, or combined with water or additional amine compound before being reintroduced into the CO₂ capture apparatus 104. In some embodiments, the recycle line fluidly couples the electrochemical apparatus 118 to the CO₂ capture apparatus 104, either directly or indirectly. The CO₂ capture apparatus 104, the CO₂ mineralization apparatus 110, and the electrochemical apparatus 118 are coupled together in the CO₂ capture and amine regeneration system 100, with the apparatuses being in fluid communication with one another. Components (e.g., pipelines, pumps, line filters, valves, temperature detectors, pressure detectors, and the like) for coupling the apparatuses are not described herein but various conventional components would be in accord with embodiments of the disclosure. Components, such as tubing, seals, spacers, pump components, and chambers, in fluid communication with amine-containing liquids may include materials resistant to chemical degradation by the amine-containing liquid. By including the CO₂ capture apparatus 104, the CO₂ mineralization apparatus 110, and the electrochemical apparatus 118 in the CO₂ capture and amine regeneration system 100, metals of interest and the amine compound may be recovered at the same location. In other words, conducting a single cycle of the methods according to embodiments of the disclosure may produce a concentrate solution or solid including the metals of interest, the amine compound, and other products with reduced or minimal transportation costs.

The CO₂ capture apparatus 104 may be configured to receive the amine-H₂O feedstream 102. The amine-H₂O feedstream 102 may include two phases, an organic phase and an aqueous phase. The organic phase may include the amine compound and the aqueous phase may include water.

The amine compound may include a primary, secondary, or tertiary amine compound (e.g., R—NH₂, R₂—NH, or R₃—N, where R is an organic group), or combinations thereof. The organic groups bonded to the nitrogen may include alkyl groups, aromatic groups, or groups containing heteroatoms (e.g., phosphorus-containing groups). In some embodiments the amine compound may be a phase change solvent (i.e., a solvent that undergoes a distinct phase transition in response to specific conditions). In these embodiments, the amine compound may initially exist in the amine-H₂O feedstream 102 as a separate, water-insoluble phase. Upon absorption of the CO₂ from the CO₂ feedstream 106, the amine compound may react to form a hydrophilic species (e.g., a carbamate compound), resulting in increased solubility and the formation of a homogeneous aqueous solution in the CO₂ capture apparatus 104. For example, the amine compound may include, but is not limited to, one or more of methyl cyclohexylamine (MCA), aminomethyl propanol (AMP), methyldiethanolamine (MDEA), cyclohexylamine, ethylcyclohexylamine, methylethanolamine, diglycolamine (DGA), piperazine (PZ), diethanolamine (DEA), diisopropanolamine (DIPA), 1-cyclohexylpiperidine (CHP), and hexamethylenediamine (HMDA). The amine compound may be commercially available from numerous sources. The amine-H₂O feedstream 102 may include the amine compound at a concentration of from about 10% by weight (wt. %) to about 55 wt. %, such as from about 10 wt. % to about 20 wt. %, from about 20 wt. % to about 30 wt. %, from about 30 wt. % to about 40 wt. %, from about 40 wt. % to about 50 wt. %, or from about 50 wt. % to about 55 wt. %, with the balance being water. For example, in some embodiments, the amine-H₂O feedstream 102 may include the amine compound at a concentration of about 30 wt. % and the water at a concentration of about 70 wt. %.

The CO₂ capture apparatus 104 may also be configured to receive the CO₂ feedstream 106. The CO₂ feedstream 106 may include a concentrated stream of gaseous CO₂, or a diluted gaseous stream of CO₂ including the CO₂ at a concentration of from about 10% by volume to about 30% by volume, with the balance being nitrogen. The CO₂ of the CO₂ feedstream 106 may come into contact with the amine-H₂O feedstream 102, forming the CO₂-saturated amine stream 108. For example, in some embodiments the CO₂ feedstream 106 may be bubbled through the amine-H₂O feedstream 102. In other embodiments, the CO₂ capture apparatus 104 may utilize a packed column, in which the CO₂ feedstream 106 flows in a countercurrent direction to the amine-H₂O feedstream 102 across high-surface-area packing material to maximize gas-liquid contact. In other embodiments, the CO₂ capture apparatus 104 may employ a membrane-based module that facilitates selective transport of the CO₂ into the amine-H₂O feedstream 102 through a CO₂-permeable membrane, which may be operated under a pressure gradient to enhance flux. In some embodiments, the temperature of the amine-H₂O feedstream 102 may be maintained in a range of from about 20° C. to about 80° C., such as from about 20° C. to about 40° C., from about 40° C. to about 60° C., or from about 60° C. to about 80° C. In some embodiments, the CO₂ feedstream 106 may be introduced into the amine-H₂O feedstream 102 under elevated pressure (e.g., from about 1 atm to about 10 atm, such as from about 1 atm to about 5 atm or from about 5 atm to about 10 atm), which may increase the solubility of the CO₂ and enhance absorption efficiency.

The amine compound in the amine-H₂O feedstream 102 may react with the CO₂ via nucleophilic attack on the carbon atom of the CO₂ molecule, creating a zwitterionic intermediate that may subsequently rearrange or undergo proton transfer to generate carbamate ions (e.g., RNHCOO⁻). Additionally, bicarbonate ions (HCO₃⁻) may form due to hydrolysis of the carbamate ions. Thus, bicarbonate ions and carbamate ions may be in equilibrium with one another in the CO₂-saturated amine stream 108. The amino group of the amine compound may form reversible chemical bonds with the CO₂, sequestering the CO₂ in the liquid phase to form the CO₂-saturated amine stream 108. The amine compound may react with the CO₂ feedstream 106 until the amine-H₂O feedstream 102 is saturated with CO₂, forming the CO₂-saturated amine stream 108. The CO₂-saturated amine stream 108 may be a substantially single-phase aqueous solution, including the amine compound and the absorbed CO₂, present as dissolved carbamate or bicarbonate species within the aqueous phase. The shift from a two-phase composition to a single-phase solution upon saturation of the amine-H₂O feedstream 102 with the CO₂ may serve as a visual indicator of saturation.

The CO₂-saturated amine stream 108 may be introduced into the CO₂ mineralization apparatus 110 along with the metal-containing feedstream 112 to form an amine-metal composition. For example, the CO₂-saturated amine stream 108 may be combined with the metal-containing feedstream 112. The metal-containing feedstream 112 may include one or more metal-containing compositions such as, but not limited to, a lithium-ion battery leachate, a solution of transition metals, or other aqueous metal sources. For example, the metal-containing feedstream 112 may include one or more of lithium, cobalt, nickel, manganese, copper, iron, chromium, zinc, lead, aluminum, and magnesium. The dissolved CO₂ (e.g., bicarbonates, carbamates) in the CO₂-saturated amine stream 108 may react with metal cations in the metal-containing feedstream 112, which precipitate and form one or more metal salts 114 (e.g., metal carbonates) that contain carbon. For example, in a metal-containing feedstream 112 including lithium-ion battery leachate, dissolved metal cations such as cobalt (Co²⁺), manganese (Mn²⁺), calcium (Ca²⁺), and nickel (Ni²⁺) may react with bicarbonates in the CO₂-saturated amine stream 108 to form cobalt carbonate, nickel carbonate, manganese carbonate, and calcium carbonate. Lithium (Li⁺) may react with carbonates to form lithium carbonate, though lithium carbonate is more soluble than transition-metal carbonates and may remain in solution, along with the amine compound and any additional metals (i.e., unreacted metal cations) of the metal-containing feedstream 112. In some embodiments, additional CO₂ is introduced into (e.g., bubbled through) the mineralization apparatus 110 to provide sufficient carbon for metal precipitation and to convert lithium carbonate to lithium bicarbonate, which is more soluble than lithium carbonate. The CO₂ mineralization apparatus 110 may be operated at or near room temperature, e.g., at a temperature of from about 18° C. to about 50° C., such as from about 18° C. to about 22° C., from about 22° C. to about 26° C., from about 26° C. to about 30° C., from about 30° C. to about 40° C., or from about 40° C. to about 50° C. The amine-metal composition may have a pH of from about 6 to about 11, such as from about 6 to about 7, from about 7 to about 8, from about 8 to about 9, from about 9 to about 10, or from about 10 to about 11.

Without being bound by theory, selective precipitation in the disclosed processes may occur because certain divalent metal species have a greater tendency to form relatively insoluble carbonate-containing solids under the disclosed conditions, while certain monovalent metal species remain solubilized in the liquid phase. Thus, in some embodiments, the disclosed mineralization act preferentially removes calcium and/or other divalent metals from the feedstream while permitting lithium to remain in solution for subsequent electrochemical recovery.

Vacuum filtration or other separation techniques (e.g., centrifugation, membrane filtration, etc.) may be employed to separate the one or more metal salts 114 from the remaining liquid of the amine-metal composition. This separation may yield the one or more metal salts 114 in the form of a solid mass (e.g., a solid filter cake) and an aqueous amine-metal solution 116 that may include the amine, additional metals of the metal-containing feedstream 112, and other soluble components (e.g., bicarbonates, impurities, etc.). The amine-metal solution 116 may then be directed to the electrochemical apparatus 118, and the solid metal salts 114 may be subjected to further separation strategies, such as exploiting differences in solubility (e.g., selective dissolution, fractional crystallization, etc.), and recovered. For example, one metal salt 114 may be soluble under specific pH conditions while another metal salt 114 may precipitate. Such selective precipitation processes may be used to separate and recover distinct metal salts 114 of value. Subsequent phases of purification may include washing, pH adjustments, or chemical additions to increase yields of targeted metal salts 114 for industrial or commercial applications. By way of example only, lithium may be recovered if a lithium-ion battery leachate is used as the metal-containing feedstream 112.

The CO₂ mineralization apparatus 110 may remove divalent cations, such as calcium (Ca²⁺), from the metal-containing feedstream 112. The presence of the divalent cations in the electrochemical apparatus 118 may otherwise lead to scaling and fouling of cation and anion exchange membranes, which may significantly reduce operational efficiency. By precipitating calcium and other divalent cations, the amine-metal solution 116 entering the electrochemical apparatus 118 may have a reduced cation load, mitigating fouling and extending membrane lifespan.

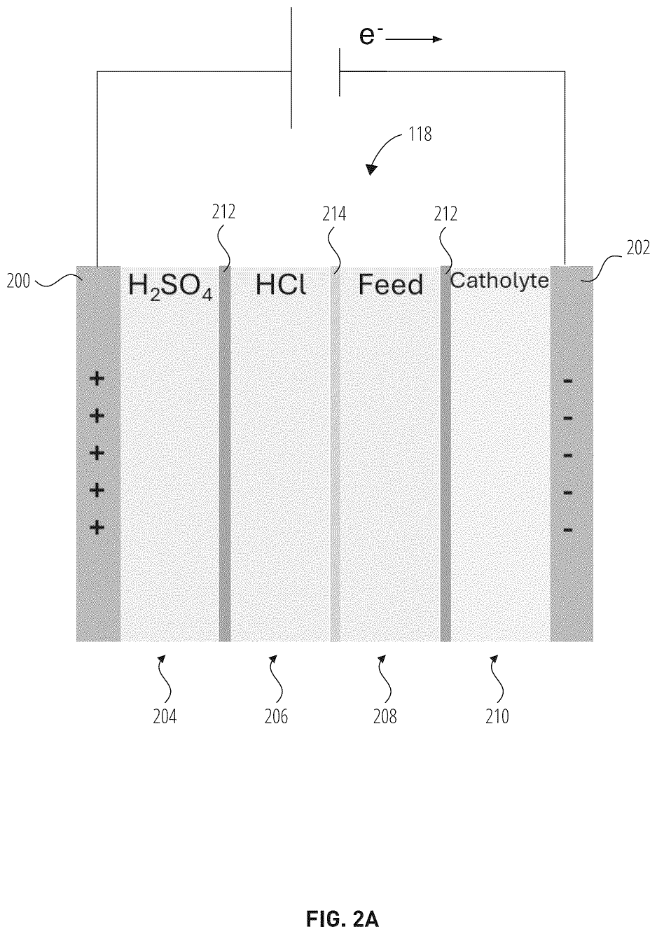

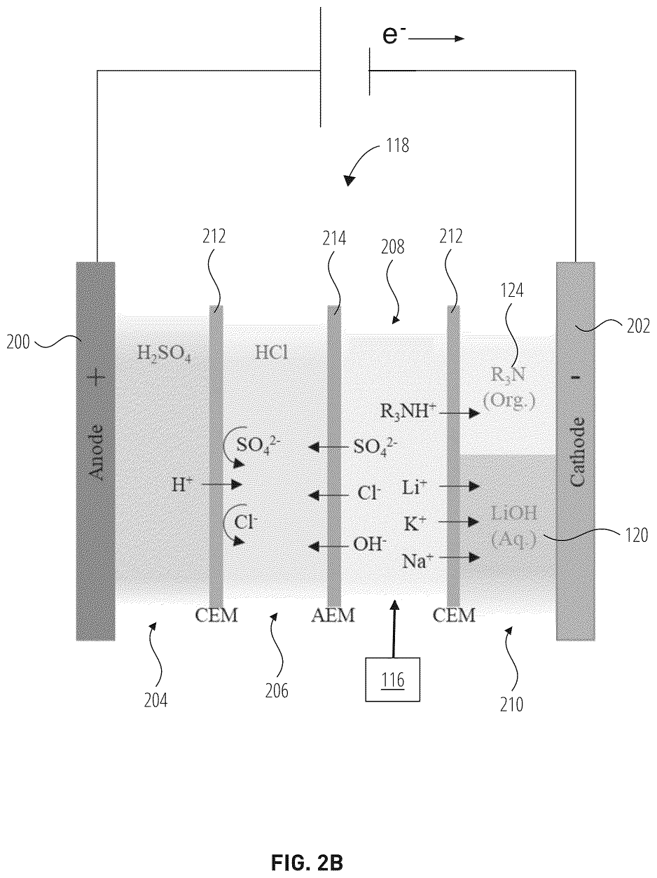

Following mineralization of the CO₂, the amine-metal solution 116 may be introduced into the electrochemical apparatus 118, as discussed in further detail below with relation to FIG. 2A and FIG. 2B.

FIG. 2A illustrates the electrochemical apparatus 118 of FIG. 1 according to embodiments of the disclosure. The electrochemical apparatus 118 includes one or more electrochemical cells that include an anode 200 and a cathode 202. The anode 200 and cathode 202 are separated from one another by chambers, with membranes 212, 214 separating the chambers from one another. The electrochemical apparatus 118 includes an anolyte chamber 204 adjacent to the anode 200, an acid chamber 206 adjacent to the anolyte chamber 204, a feed chamber 208 adjacent to the acid chamber 206, and a catholyte chamber 210 disposed between the feed chamber 208 and cathode 202. Cation exchange membranes 212 are disposed between the anolyte chamber 204 and the acid chamber 206 and between the feed chamber 208 and the catholyte chamber 210. An anion exchange membrane 214 is disposed between the acid chamber 206 and the feed chamber 208.

The anode 200 may be formed of and include a material suitable for conducting electricity and exhibiting a tolerance to (e.g., chemical resistance to) aqueous solutions (e.g., water, hydroxide ions, etc.). In some embodiments, the anode 200 is a dimensionally stable anode (DSA), including but not limited to a metal oxide-coated titanium electrode (e.g., iridium oxide on titanium, platinum on titanium), high-entropy alloys, or combinations thereof. However, the disclosure is not so limited and the anode 200 may include one or more materials other than, or in addition to, those described. The cathode 202 may be formed of and include a material suitable for conducting electricity and exhibiting a tolerance to an electrolyte in the catholyte chamber 210. In some embodiments, the cathode 202 is formed of and includes stainless steel. The anode 200 and the cathode 202 may be connected by an external power source, and a voltage of from about 3V to about 7V may be applied between them, such as from about 3V to about 4.5V or from about 4.5V to about 6V. The anode 200 may be biased with a positive potential and the cathode 202 may be biased with a negative potential. Thus, the anode 200 and cathode 202 may create an electric field across the chambers 204, 206, 208, 210 of the electrochemical apparatus 118, transporting cations towards the cathode 202 and anions towards the anode 200.

The cation exchange membranes 212 may be disposed between the anolyte chamber 204 and the acid chamber 206, and between the feed chamber 208 and the catholyte chamber 210. The cation exchange membranes 212 may be configured to selectively permit cation transport while restricting anion flow, and may include materials such as, but not limited to, sulfonated polymers or other ionomeric materials that provide stable conductivity in acidic or basic environments.

The anion exchange membrane 214 may be disposed between the acid chamber 206 and the feed chamber 208. The anion exchange membrane 214 may selectively permit the passage of anionic species, such as chloride ions or sulfate ions, while restricting the flow of cations (e.g., metal cations, protonated amines, etc.). In operation, the anion exchange membrane 214 may facilitate efficient charge balance in the electrochemical apparatus 118 by allowing negatively charged ions to flow between the feed chamber 208 and the acid chamber 206, while retaining cations in the feed chamber 208.

The anolyte chamber 204 may be positioned adjacent to and in direct contact with the anode 200. The anolyte chamber 204 may include an anolyte solution that includes, but is not limited to, sulfuric acid, hydrochloric acid, phosphoric acid, or nitric acid. The anolyte chamber 204 may promote generation of protons as electrons are removed at the anode 200. The anolyte chamber 204 may thus facilitate creating and maintaining an acidic environment in the electrochemical apparatus 118 suitable for driving cation movement across the cation exchange membranes 212.

The acid chamber 206 may be positioned adjacent to the anolyte chamber 204 and separated from it by a cation exchange membrane 212. Cations, but not anions, may flow through the cation exchange membrane 212. The acid chamber 206 may include an acidic solution, including, but not limited to, hydrochloric acid, sulfuric acid, phosphoric acid, or nitric acid. Protons may accumulate within the acid chamber 206, leading to acidic conditions. The acid chamber 206 may serve as a reservoir for acidic effluent, helping control pH gradients within the electrochemical apparatus 118. Cations (e.g., protons) may selectively flow into the acid chamber 206 through the cation exchange membrane 212 from the anolyte chamber 204. Anions from the feed chamber 208 may flow into the acid chamber 206 through the anion exchange membrane 214. However, the anions are blocked from entering the anolyte chamber 204 by the cation exchange membrane 212.

The feed chamber 208 may be positioned adjacent to the acid chamber 206 and separated from the acid chamber 206 by the anion exchange membrane 214. The feed chamber 208 may be configured to receive the amine-metal solution 116 containing the amine compound and additional metals. For example, the amine-metal solution 116 may be flowed through the feed chamber 208. The flowrate of the amine-metal solution through the feed chamber may be from about 0.1 liters per minute (L/min) to about 100,000 L/min, such as from about 0.1 L/min to about 20 L/min, about 20 L/min to about 500 L/min, about 500 L/min to about 50,000 L/min, or about 50,000 L/min to about 100,000 L/min.

The catholyte chamber 210 may be disposed between the feed chamber 208 and the cathode 202, with the cation exchange membrane 212 disposed between the feed chamber 208 and catholyte chamber 210. The catholyte chamber 210 may be in direct contact with the cathode 202. The catholyte chamber 210 may include a catholyte solution including, but not limited to, one or more of lithium, sodium, magnesium, and potassium. Under the influence of the electric field, cations (e.g., metal cations, protonated amines, etc.) may migrate from the feed chamber 208 across the cation exchange membrane 212 into the catholyte chamber 210. As discussed in further detail below, water may be reduced by electrons at the cathode 202 to produce hydroxide ions (OH⁻), leading to a pH increase and the formation of the metal solution 120 (e.g., metal hydroxides, metal carbonates, etc.). The increase in pH may facilitate deprotonation of the amines, leading to the formation in the catholyte chamber 210 of a distinct upper organic phase including the deprotonated amine compound (i.e., recycled amine compound 124) and a lower aqueous phase including the metal solution 120. The metal solution 120 and the amine compound may be separately recovered from the electrochemical apparatus 118. The aqueous phase including the metal solution 120 may be in a relatively smaller volume than the organic phase containing the amine compound, enabling use of the metal solution 120 in subsequent processes.

The electrochemical apparatus 118 may be operated at or near room temperature, e.g., at a temperature of from about 18° C. to about 30° C., such as from about 18° C. to about 22° C., from about 22° C. to about 26° C., or from about 26° C. to about 30° C. By operating at or near room temperature, the electrochemical apparatus 118 may consume far less energy than conventional amine regeneration systems and methods.

Although the electrochemical apparatus 118 as illustrated includes four chambers, in other embodiments, the electrochemical apparatus 118 may include three chambers. In three-chamber embodiments (not shown), the electrochemical apparatus 118 may include an anolyte chamber 204 adjacent to the anode 200, a feed chamber 208 adjacent to the anolyte chamber 204, and a catholyte chamber 210 between the anolyte chamber 204 and the cathode 202. A separate acid chamber 206 may not be present in (e.g., may be omitted from) the three-chamber electrochemical apparatus 118. An anion exchange membrane 214 may separate the anolyte chamber 204 from the feed chamber 208, while a cation exchange membrane 212 may be disposed between the feed chamber 208 and the catholyte chamber 210.

FIG. 2B illustrates the electrochemical apparatus of FIG. 2A at a particular stage of operation according to embodiments of the disclosure. As discussed above, the anode 200 and cathode 202 of the electrochemical apparatus 118 may be connected by an external power source that creates an electric field across the electrochemical apparatus 118. The anode 200 may be connected to a positive terminal of the power source and biased with a positive potential, and the cathode 202 may be connected to a negative terminal of the power source and biased with a negative potential. Electrons may flow from the negative terminal of the power source to the cathode 202. In turn, electrons may exit the electrochemical apparatus 118 via the anode 200 and return to the positive terminal of the power supply. This electron flow may drive reduction reactions at or near the cathode 202 and oxidation reactions at or near the anode 200, creating and sustaining electrochemical gradients that drive ion migration through the membranes 212, 214.

The amine-metal solution 116 including the amine compound and additional metals (such as, but not limited to, Li⁺, Na⁺, K⁺, etc.) may be introduced into (e.g., flowed through) the feed chamber 208 at a controlled rate (e.g., at a rate of from about 0.1 L/min to about 100,000 L/min). Under the acidic conditions of the electrochemical apparatus 118, the amine compound may be protonated to form a protonated amine compound. Under the influence of the electric field, positively charged species (e.g., the protonated amine compound, metal cations, etc.) in the amine-metal solution 116 may migrate from the feed chamber 208 across the cation exchange membrane 212 into the catholyte chamber 210, while negatively charged species (e.g., sulfate anions, chloride anions, hydroxide anions, etc.) may migrate from the feed chamber 208 across the anion exchange membrane 214 into the acid chamber 206.

Within the catholyte chamber 210, water reduction reactions at or near the cathode 202 generate hydroxide ions. These hydroxide ions may react with the additional metals (e.g., Li⁺, Na⁺, K⁺, etc.) from the amine-metal solution 116 to form corresponding metal compounds in the metal solution 120 (such as, but not limited to, lithium hydroxide, sodium hydroxide, and potassium hydroxide). The generation of the hydroxide ions may also increase the pH of the catholyte environment, facilitating deprotonation of the amines (e.g., R₃NH⁺→R₃N). Because the deprotonated amines are more hydrophobic than the metal solution 120, the deprotonated amine compound (i.e., recycled amine compound 124) may separate into an upper organic layer including the recycled amine compound 124 in the catholyte chamber 210, whereas the metal solution 120 may remain in an aqueous phase at a lower portion of the catholyte chamber 210. In some embodiments, the upper organic layer comprising the recycled amine compound 124 may be withdrawn from the catholyte chamber 210 and directed through a recycle line to the CO₂ capture apparatus 104 for reuse. In some embodiments, the recycle line fluidly couples the catholyte chamber 210 (e.g., the upper portion of the catholyte chamber 210) to the CO₂ capture apparatus 104. In certain embodiments, each phase may be separately withdrawn on a continuous or batch basis: the recycled amine compound 124 may be skimmed or decanted from the upper portion and, after further processing (e.g., concentration, purification, etc.), introduced back into the CO₂ capture apparatus 104, while the metal solution 120 may be recovered from the lower portion and recycled or used in industrial applications. The metal solution 120 may include from about 30% to about 95% of the additional metals present in the amine-metal solution, such as from about 30% to about 45%, from about 45% to about 60%, from about 60% to about 70%, from about 70% to about 85%, or from about 85% to about 95%. The recycled amine compound 124 may include from about 30% to about 95% of the amine compound present in the amine-metal solution, such as from about 30% to about 45%, from about 45% to about 60%, from about 60% to about 70%, from about 70% to about 85%, or from about 85% to about 95%. By way of example only, lithium may be recovered if the metal-containing feedstream was a lithium-ion battery leachate.

Under the electric field, sulfate and other anions may migrate into the acid chamber 206, while protons flow across the cation exchange membrane 212 from the anolyte chamber 204 to the acid chamber 206. Consequently, in embodiments where the amine-metal solution 116 includes sulfates (e.g., Li₂SO₄, Na₂SO₄, etc.) in relatively higher amounts, an acid effluent stream 122 including sulfuric acid (H₂SO₄) or other acids may be produced in the acid chamber 206 that may be withdrawn from the electrochemical apparatus 118, providing an economically valuable byproduct for downstream use.

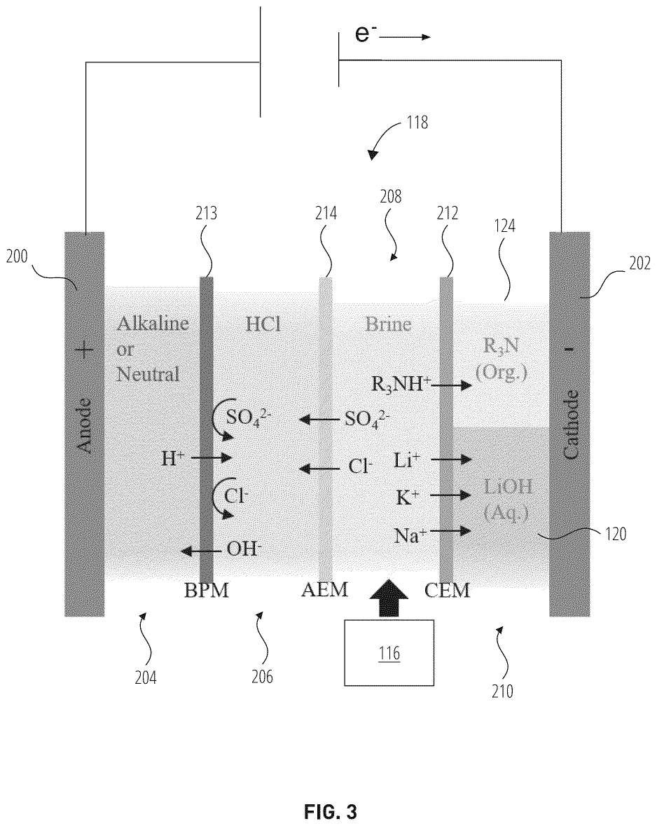

Referring next to FIG. 3, in some embodiments the electrochemical apparatus 118 includes a bipolar membrane 213 (rather than a cation exchange membrane 212 as previously described with FIG. 2B) disposed between the anolyte chamber 204 and the acid chamber 206. In these embodiments, the anolyte chamber 204 includes an alkaline or neutral solution that includes, but is not limited to, sodium hydroxide, potassium hydroxide, sodium carbonate, sodium chloride, or potassium chloride. The bipolar membrane 213 may prevent chloride anions from reaching the anode 200 and releasing chlorine gas or other corrosive chloride-containing products. The acid chamber 206, the feed chamber 208, the catholyte chamber 210, the anion exchange membrane 214, and the cation exchange membrane 212 of the electrochemical apparatus 118 of FIG. 3 operate in a substantially similar manner as described above with respect to FIGS. 2A-2B.

In three-chamber embodiments, when the electrochemical apparatus 118 is powered by the external power source, electrons may flow from the negative terminal of the power supply into the cathode 202, driving reduction reactions in the catholyte chamber 210 that generate hydroxide ions. These hydroxide ions may react with metal cations crossing from the feed chamber 208 through the cation exchange membrane 212, forming the metal solution 120. Meanwhile, protonated amines in the amine-metal solution 116 may be deprotonated under alkaline conditions and partition into a separate organic layer including the amine compound 124 to be recovered and recycled in the catholyte chamber 210. Anionic species may migrate from the feed chamber 208 across the anion exchange membrane 214 into the anolyte chamber 204, facilitating charge balance and allowing oxidation reactions to occur at or near the anode 200, omitting the need for a separate acid chamber 206 while achieving effective separation of the amines from the additional metals.

At industrial scales, the electrochemical apparatus according to embodiments of the disclosure may be configured by combining multiple modules of the chamber and membrane configurations described above in relation to the electrochemical apparatus 118 into a single, large-capacity unit. Each module may include an anode, a cathode, an anolyte chamber adjacent to the anode, an acid chamber adjacent to the anolyte chamber, a feed chamber adjacent to the acid chamber, and a catholyte chamber disposed between the feed chamber and the cathode. Cation exchange membranes may separate the anolyte chamber from the acid chamber and the feed chamber from the catholyte chamber, while an anion exchange membrane may separate the acid chamber from the feed chamber. In some embodiments, bipolar membranes may be integrated between modules to facilitate water splitting (i.e., controlled generation of H⁺ and OH⁻). By stacking or arranging these modules in parallel or series, large volumes of liquid filtrate containing amines and additional metals may be processed in a continuous or semi-continuous manner.

Because of their modular nature, industrial-scale electrochemical apparatuses according to embodiments of the disclosure may be built out or scaled up simply by adding more modules. The use of flow spacers, membranes, and chamber configurations facilitate the handling of different volumes and flow rates as process demands change. Additionally, each module may be taken offline for maintenance without interrupting the entire operation, enabling continuous processing and minimizing downtime. By adjusting flow rates, operating voltages, and chamber sizes, the apparatus may be tailored to specific feed compositions, enhancing the efficiency and cost-effectiveness of large-scale amine recovery and metal removal on-site, for example, at carbon capture and storage facilities or power plants.

The following examples serve to explain embodiments of the disclosure in more detail. These examples are not to be construed as being exhaustive or exclusive as to the scope of this disclosure.

### EXAMPLE 1

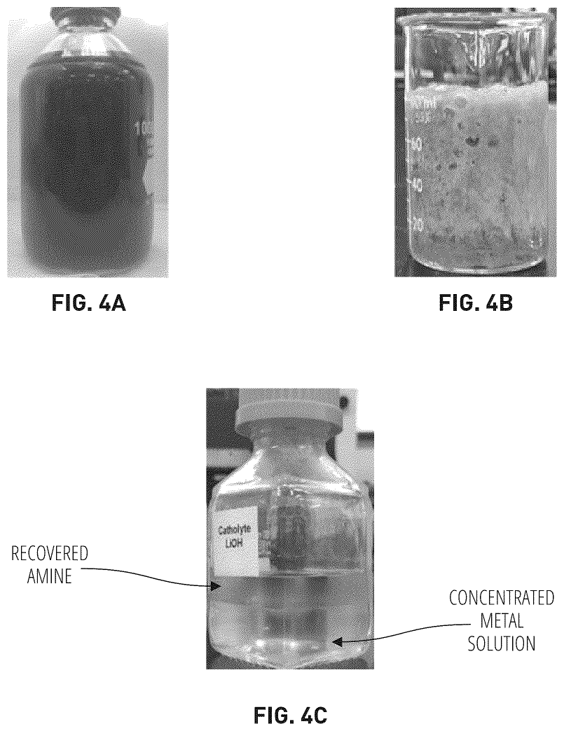

Lithium ion battery leachate compositions were mixed with a CO₂-saturated amine composition to form an amine-metal composition. An exemplary leachate composition is shown in FIG. 4A, and an exemplary amine-metal composition is shown in FIG. 4B. The CO₂-saturated amine composition included MCA as the amine compound and dissolved CO₂ species in the form of carbonate. The CO₂-saturated amine composition included approximately 30 wt. % MCA and 70 wt. % water. The resulting amine-metal composition was filtered using vacuum filtration to form a solid mass and an amine-metal solution. When the lithium-ion battery leachate was a cobalt-rich battery leachate, the solid mass contained metal salts in the form of cobalt-rich carbonates exhibiting a white color. When the lithium-ion battery leachate was a nickel-rich battery leachate, the solid mass contained metal salts in the form of nickel-rich carbonates exhibiting a light green color. The amine-metal solution contained the amine compound and additional metals. The amine-metal solution was introduced into an electrochemical apparatus according to embodiments of the disclosure to produce a two-phase liquid solution having the amine compound as a top phase and a concentrated metal solution as a bottom phase, as shown in FIG. 4C.

### EXAMPLE 2

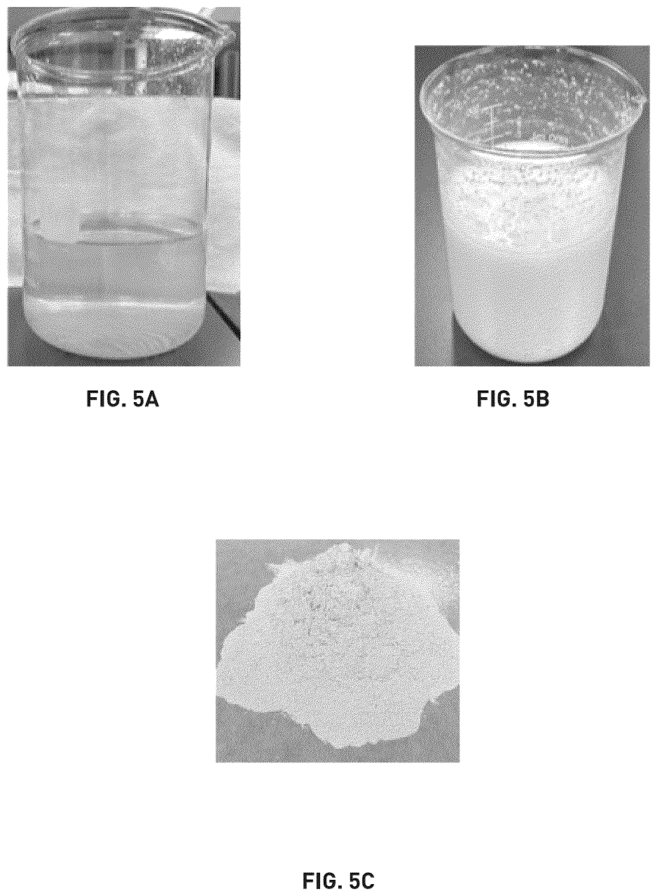

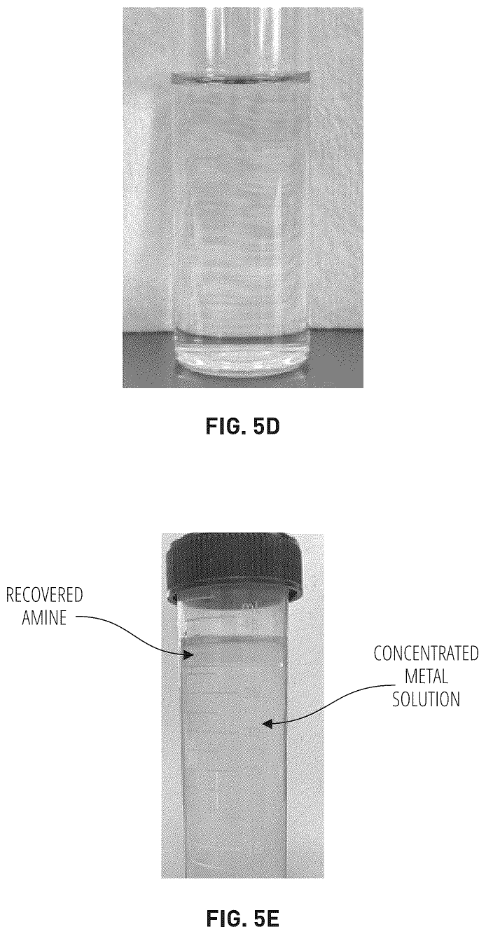

A simulated brine solution, shown in FIG. 5A, was prepared that included lithium (180.9 mg/L), calcium (896.7 mg/L), magnesium (4.5 mg/L), potassium (3194.2 mg/L), and sodium (37439.3 mg/L) at a pH of about 7. The simulated brine solution was combined with a CO₂-saturated amine composition including MCA as the amine compound and dissolved CO₂ species in the form of carbonate. The CO₂-saturated amine composition included approximately 30 wt. % MCA and 70 wt. % water.

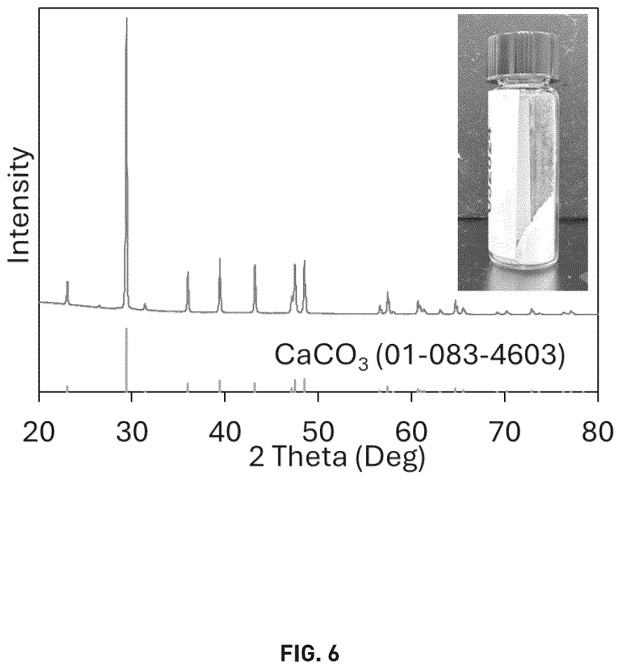

180 mL of the simulated brine solution was combined with 60 mL of the CO₂-saturated amine composition to form an amine-metal composition, and CO₂ was bubbled through the amine-metal composition over two days to ensure substantial saturation. The resulting suspension is shown in FIG. 5B. The suspension was subsequently filtered, forming a solid mass including metal salts and an amine-metal solution including the amine compound and additional metals. The solid mass is shown in FIG. 5C, and the amine-metal solution is shown in FIG. 5D. The solid mass was composed primarily of calcium carbonate, as shown in the XRD graph of FIG. 6. The amine-metal solution included MCA, lithium (143.5 mg/L), calcium (6.5 mg/L), magnesium (0.5 mg/L), potassium (1206.4 mg/L), and sodium (21300.9 mg/L). Thus, the concentration of calcium was reduced from 896.7 mg/L to 6.5 mg/L following precipitation.

Approximately 50 mL of the amine-metal solution was then treated via electrodialysis using an electrochemical apparatus according to embodiments of the disclosure. The electrochemical apparatus included a catholyte chamber with a dilute lithium solution (8.7 mg/L) to provide sufficient conductivity. After electrodialysis, a phase separation was observed on the catholyte chamber side, resulting in an upper organic phase containing the amine compound and a lower aqueous phase that contained a concentrated solution of metals, as shown in FIG. 5E. Under these conditions, approximately 85% of the lithium originally present in the simulated brine solution was recovered, and about 74.7% of the amine compound originally present in the CO₂-saturated amine composition was recovered in the catholyte chamber.

### EXAMPLE 3

Reusability of MCA in carbon capture processes was evaluated. A fresh MCA solution was prepared by mixing MCA with water to achieve a concentration of about 30 wt. %. The MCA solution was saturated with CO₂ and then combined with a surrogate brine solution, with the brine constituting about 75 vol. % of the combined liquid. Upon mixing, white precipitates formed and were separated through vacuum filtration.

The remaining liquid phase was used as a feedstock in an electrodialysis process conducted at a cell voltage of about 7 V for about 24 hours. MCA was regenerated in an upper phase within the catholyte. After a settling period of about 5 hours, two distinct phases were observed. The upper phase containing regenerated MCA measured about 3 mL, compared with about 3.3 mL in the fresh MCA solution.

The regenerated MCA recovered from the upper phase was then saturated with CO₂, combined with surrogate brine, and subjected to precipitation and filtration in a subsequent cycle. The resulting liquid phase from that cycle was again introduced into the electrodialysis process to regenerate MCA. This sequence was repeated through a total of five cycles. Regenerated MCA was recovered and reused from cycle to cycle, demonstrating that MCA was reusable in multiple carbon capture and metal recovery cycles.

### EXAMPLE 4

Pretreated brine containing lithium, sodium, and potassium, together with protonated MCA, was used as a feedstock in a three-chamber electrodialysis cell having a feedstock compartment positioned between an anodic chamber and a cathodic chamber. Electrodialysis tests were conducted under varying conditions including applied voltages of from about 4V to about 7V and durations of from about 24 hours to about 48 hours. After electrodialysis, the catholyte separated into an upper phase containing MCA and a lower aqueous phase containing lithium and additional metals. The upper phase was analyzed using ¹H nuclear magnetic resonance spectroscopy, and lithium in the lower aqueous phase was measured using atomic absorption spectroscopy.

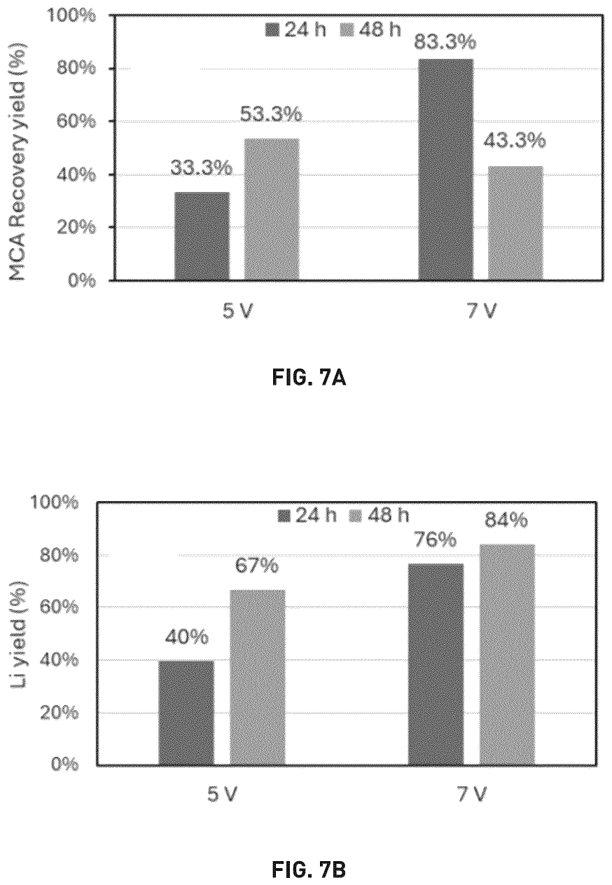

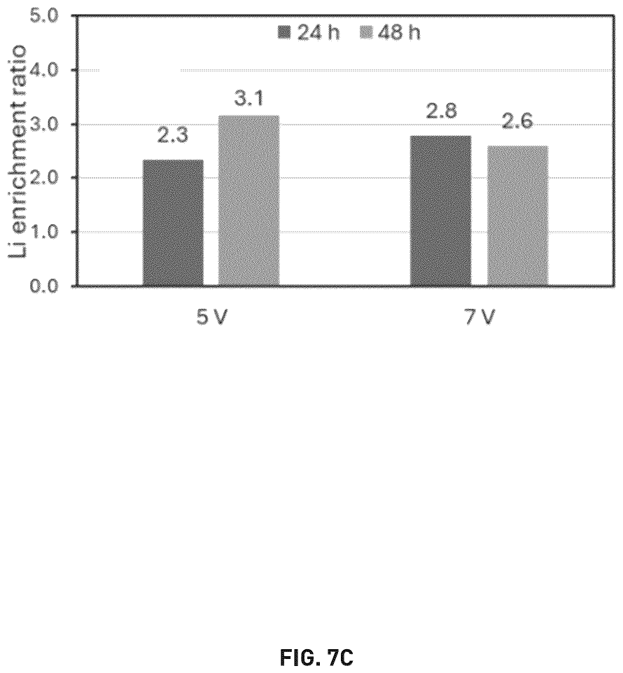

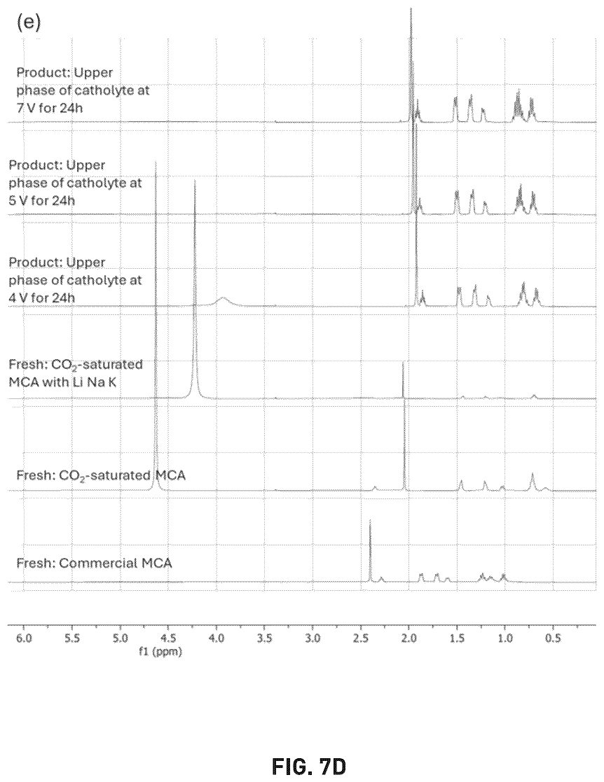

MCA recovery yields obtained under the tested voltages and durations are shown in FIG. 7A. Recovery increased with higher voltage at the 24-hour timescale, and recovery of greater than about 80% was observed at about 7V for about 24 hours. Lithium yields obtained under the tested voltages and durations are shown in FIG. 7B. Lithium yield increased with longer duration and higher voltage under the tested conditions.

Lithium enrichment ratios relative to the feedstock are shown in FIG. 7C. The lithium concentration in the product stream increased relative to the feedstock under the tested conditions. NMR spectra of fresh and recovered MCA are shown in FIG. 7D. Peaks between about 0.5 ppm and about 3.5 ppm in the recovered MCA were consistent with peaks observed in fresh MCA, indicating recovered amine purity greater than about 90%. Without being bound by theory, in some runs, longer-duration performance was affected by leakage in the electrodialysis cell and by incomplete phase separation at the time of measurement.

### EXAMPLE 5

Mineralization experiments were conducted using 2-amino-2-methyl-1-propanol (AMP), N-methylcyclohexylamine (MCA), and methyldiethanolamine (MDEA). Each amine was mixed with water to form an aqueous amine composition including about 30 wt. % amine. CO₂ was bubbled through each aqueous amine composition until saturation to form a corresponding CO₂-saturated amine composition.

In representative mineralization experiments, a CO₂-saturated amine composition was combined with a surrogate brine solution including about 211 ppm lithium, about 38,115 ppm sodium, about 3,820 ppm potassium, about 404 ppm magnesium, and about 785 ppm calcium. The volumetric ratio of the surrogate brine solution to the CO₂-saturated amine composition was within a range of from about 1:1 to about 5:1. Upon mixing, precipitation of metal-containing solids was observed. The solids were separated from the liquid phase by vacuum filtration.

Metal concentrations in the liquid and solid phases were analyzed, and the solids were further characterized by X-ray diffraction. Calcium precipitation exceeded about 99%, magnesium precipitation was about 60%, and precipitation of monovalent metals including lithium, sodium, and potassium was less than about 0.5%. X-ray diffraction indicated the presence of calcium carbonate and magnesium carbonate in the solids. These results showed selective precipitation of divalent metal carbonates while at least a substantial portion of monovalent metals remained in solution.

### EXAMPLE 6

Additional mineralization experiments were conducted using MCA and the surrogate brine solution of Example 5. A CO₂-saturated MCA composition was combined with the surrogate brine solution at a brine-to-amine volumetric ratio of about 3:1. In a first test, CO₂ was continuously bubbled through the combined liquid during mixing. In a second test, the CO₂-saturated MCA composition was mixed with the surrogate brine solution without continued CO₂ bubbling after saturation of the MCA composition.

In both tests, solid precipitates formed and were separated from the remaining liquid by vacuum filtration. Calcium precipitation exceeded about 99% in both tests. Magnesium precipitation was about 95% when CO₂ was continuously bubbled through the combined liquid during mixing and about 58% when CO₂ was not continuously bubbled through the combined liquid during mixing. Precipitation of monovalent metals including lithium, sodium, and potassium was less than about 0.5% under the tested conditions. These results showed that continued CO₂ addition during mixing may increase precipitation of at least some divalent metals, such as magnesium, while maintaining relatively low precipitation of monovalent metals in the liquid phase.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method for CO₂ capture and metal recovery, comprising:
combining CO₂ with a solution comprising an amine compound to form a CO₂-amine stream;
combining the CO₂-amine stream with a metal-containing feedstream to form one or more metal salts and an amine-metal solution, the one or more metal salts comprising carbon, the amine-metal solution comprising the amine compound and additional metals of the metal-containing feedstream;
recovering the one or more metal salts;
electrochemically separating the amine compound from the additional metals of the amine-metal solution;
recovering the amine compound; and
recovering one or more of the additional metals.

2. The method of claim 1, wherein combining CO₂ with a solution comprising an amine compound comprises combining the CO₂ with the solution comprising one or more of methyl cyclohexylamine (MCA), aminomethyl propanol (AMP), methyldiethanolamine (MDEA), cyclohexylamine, ethylcyclohexylamine, methylethanolamine, diglycolamine (DGA), piperazine (PZ), diethanolamine (DEA), diisopropanolamine (DIPA), 1-cyclohexylpiperidine (CHP), and hexamethylenediamine (HMDA).

3. The method of claim 1, wherein electrochemically separating the amine compound from the additional metals comprises:
providing an electrochemical apparatus comprising an anode, a cathode, an anolyte chamber adjacent to and in direct contact with the anode, an acid chamber adjacent to the anolyte chamber and separated therefrom by a first cation exchange membrane, a feed chamber adjacent to the acid chamber and separated therefrom by an anion exchange membrane, and a catholyte chamber adjacent to the feed chamber and separated therefrom by a second cation exchange membrane;
introducing the amine-metal solution into the feed chamber;
applying a voltage between the anode and the cathode;
migrating the amine compound and the additional metals of the amine-metal solution from the feed chamber across the second cation exchange membrane into the catholyte chamber;
migrating negatively charged species from the feed chamber across the anion exchange membrane into the acid chamber; and
migrating protons from the anolyte chamber across the first cation exchange membrane into the acid chamber.

4. The method of claim 3, further comprising:
generating hydroxide ions in the catholyte chamber;
reacting at least a portion of the hydroxide ions with the additional metals to form a metal solution in the catholyte chamber;
deprotonating the amine compound in the catholyte chamber to form a deprotonated amine compound;
forming an upper organic phase comprising the deprotonated amine compound in the catholyte chamber; and
separating the upper organic phase from a lower aqueous phase comprising the additional metals.

5. The method of claim 4, further comprising:
recovering the upper organic phase comprising the deprotonated amine compound; and
recovering the lower aqueous phase comprising the additional metals.

6. The method of claim 1, wherein combining the CO₂-amine stream with a metal-containing feedstream comprises combining the CO₂-amine stream with a metal-containing solution comprising one or more of lithium, cobalt, nickel, manganese, copper, iron, chromium, zinc, lead, aluminum, and magnesium.

7. The method of claim 1, wherein recovering the one or more metal salts comprises recovering one or more metal carbonate compounds.

8. A CO₂ capture and amine regeneration system, comprising:
a CO₂ capture apparatus configured to absorb CO₂ and form a CO₂-amine amine composition;
a CO₂ mineralization apparatus configured to contain a metal-containing feedstream, the CO₂ mineralization apparatus configured to receive the CO₂-amine composition, mineralize the CO₂, and produce an amine-metal solution comprising the amine and additional metals of the metal-containing feedstream; and
an electrochemical apparatus configured to receive the amine-metal solution comprising the amine and the additional metals and to separate the amine from the additional metals.

9. The CO₂ capture and amine regeneration system of claim 8, wherein the electrochemical apparatus comprises:
an anode;
a cathode;
an anolyte chamber adjacent to and in direct contact with the anode;
an acid chamber adjacent to the anolyte chamber, the acid chamber separated from the anolyte chamber by a cation exchange membrane;
a feed chamber adjacent to the acid chamber, the feed chamber separated from the acid chamber by an anion exchange membrane and configured to receive the amine-metal solution; and
a catholyte chamber disposed between the feed chamber and the cathode, the catholyte chamber separated from the feed chamber by a cation exchange membrane.

10. The CO₂ capture and amine regeneration system of claim 8, wherein the electrochemical apparatus comprises:
an anode;
a cathode;
an anolyte chamber adjacent to and in direct contact with the anode;
a feed chamber adjacent to the anolyte chamber, the feed chamber separated from the anolyte chamber by an anion exchange membrane and configured to receive the amine-metal solution; and
a catholyte chamber disposed between the feed chamber and the cathode, the catholyte chamber separated from the feed chamber by a cation exchange membrane.

11. The CO₂ capture and amine regeneration system of claim 8, wherein the electrochemical apparatus is fluidly coupled to the CO₂ capture apparatus and configured to direct the separated amine from the electrochemical apparatus to the CO₂ capture apparatus.

12. The CO₂ capture and amine regeneration system of claim 8, wherein the CO₂ mineralization apparatus is configured to precipitate one or more divalent metal cations from the metal-containing feedstream before the amine-metal solution is introduced into the electrochemical apparatus.

13. The CO₂ capture and amine regeneration system of claim 8, wherein the electrochemical apparatus comprises electrochemical modules arranged in parallel, in series, or both, each of the electrochemical modules independently configured to continuously or semi-continuously separate the amine from the additional metals.

14. A method for CO₂ capture and lithium recovery, comprising:
combining CO₂ with a composition comprising methyl cyclohexylamine (MCA) to form a CO₂-MCA composition;
combining the CO₂-MCA composition with a lithium-containing solution comprising one or more additional metals to form a solid mass comprising one or more metal carbonates and a liquid filtrate comprising the MCA and the lithium; and
electrochemically separating the MCA from the lithium in the liquid filtrate to form an MCA-containing phase and a lithium-containing phase.

15. The method of claim 14, wherein forming the solid mass comprising one or more metal carbonates and the liquid filtrate comprises forming the one or more metal carbonates comprising one or more of cobalt carbonate, nickel carbonate, manganese carbonate, and calcium carbonate.

16. The method of claim 14, wherein the lithium-containing solution comprises calcium, and wherein combining the CO₂-MCA composition with the lithium-containing solution comprises forming the solid mass comprising calcium carbonate.

17. The method of claim 14, wherein electrochemically separating the MCA from the lithium in the liquid filtrate comprises introducing the liquid filtrate into a feed chamber of an electrodialysis apparatus, the electrodialysis apparatus comprising an anolyte chamber separated from the feed chamber by an anion exchange membrane and a catholyte chamber separated from the feed chamber by a cation exchange membrane.

18. The method of claim 17, wherein electrochemically separating the MCA from the lithium in the liquid filtrate comprises:
applying a voltage across the electrodialysis apparatus;
generating hydroxide ions in the catholyte chamber;
deprotonating the MCA in the catholyte chamber; and
separating, in the catholyte chamber, an upper organic phase comprising deprotonated MCA from a lower aqueous phase comprising lithium.

19. The method of claim 18, wherein separating the upper organic phase comprising the deprotonated MCA from the lower aqueous phase comprising lithium comprises separating the lithium hydroxide from the upper organic phase.

20. The method of claim 14, further comprising:
recovering the MCA-containing phase; and
combining MCA from the MCA-containing phase with CO₂ to form a subsequent CO₂-MCA composition.
